(19) United States
(12) Patent Application Publication
(10) Pub. No.: US 2007/0033198 A1
(43) Pub. Date: Feb. 8, 2007

(54) DATA REPRESENTATION ARCHITECTURE FOR MEDIA ACCESS

(76) Inventor: ANTHONY DEFRIES, LOS ANGELES, CA (US)

Correspondence Address: MAINMAN LTD., 1922 BEL AIR RD., LOS ANGELES, CA, 90077, US

(21) Appl. No.: 11/460,458

(22) Filed: Jul. 27, 2006

Related U.S. Application Data
(60) Provisional application No. 60/704,441, filed on Aug. 2, 2005.
(60) Provisional application No. 60/706,021, filed on Aug. 8, 2005.

(51) Int. Cl. G06F 17/30

(52) U.S. Cl. 707/10

(57) ABSTRACT

This invention concerns a method or means to provide an architecture for distribution of data and access on or over any one or many forms of communications, telecommunications, information, Internet or Intranet access infrastructure. Said architecture may include a means or method of data compression by the use of software coding for objectification, visualization or integration of data. The method of use of the invention described herein may include a search engine or browser platform. This invention further concerns a method and means to use mathematical algorithms or transforms to plot the motion and momenta of real or simulated particles in space. Said method may include a means to represent such data as bounded spatial coordinates in a many body system and to express such data as a bounded figure, which may include a curve or any other form. The method of such representation may include a means for the purpose of one or any of data reduction, encryption, security, duplication, compression, storage, transmission, distribution, management or any other purpose. In a further aspect of this invention data may be represented as a two-dimensional planar curve corresponding to the positions and momenta of the parametric transform particles.

### RELATED APPLICATIONS

This application claims benefit of and priority to U.S. Provisional Patent Applications No. 60/704,441 filed Aug. 2, 2005 entitled “Method to represent data as bounded spatial coordinates,” herein incorporated by reference in its entirety and U.S. Provisional Patent Application No. 60/706,021 filed Aug. 8, 2005 entitled “Method to provide a search engine or browser platform with a distributed shared functionality for specialized media access featuring dedicated mathematical algorithms and transforms,” herein incorporated by reference in its entirety.

### BACKGROUND

1. Field

This invention concerns a method or means to provide an architecture which may be used for distribution of data and access on or over any one or many forms of communications, telecommunications, information, Internet or Intranet access infrastructure. Said architecture may include a means or method of data compression by the use of software coding for objectification, visualization or integration of data. The method of use of the invention described herein may include a search engine or browser platform. This invention further concerns a method and means to use mathematical algorithms or transforms to plot the motion and momenta of real or simulated particles in space. Said method may include a means to represent such data as bounded spatial coordinates in a many body system and to express such data as a bounded figure which may include a curve or any other form. The method of such representation may include a means for the purpose of one or any of data reduction, encryption, security, duplication, compression, storage, transmission, distribution, management or any other purpose. In a further aspect of this invention data may be represented as a two-dimensional planar curve corresponding to the positions and momenta of the parametric transform particles.

2. Related Art

Access to and distribution of media content and related information is a significant function of communications, telecommunications or information activity including Internet and Intranet use. Current methods and means of distribution and data formats place many constraints on this traffic. Network access points and gateways that support the communications, telecommunications or information infrastructure including the Internet and Intranet are expressed in hardware. Traffic is directed by means of dedicated servers and server networks which interface with multiple layers of distribution in different modes. The bandwidth available varies tremendously between different portions of the system and is influenced by many factors. Physical hardware and software limitations resulting from increased traffic and diminished processing power or reduced carrying capacity play a large role in such constraints.

Objectification or visualization of data would improve the efficiency of data compression for increased processing power and additional capacity. This would enable broadband features to be realized in narrowband environments and would increase existing broadband capabilities across the entire communications, telecommunications, information, Internet or Intranet infrastructure. Benefits of the invention described herein may include improved architecture for data distribution and access combined with more efficient compression and representation of data. Further said inventions could provide increased capacity and processing power

International Standards Organizations and Working Committees are seeking to identify ways in which the existing infrastructure can better serve the Internet. Many of the necessary features required for improved performance are concerned with new data and distribution architectures, alternative coding, automated functions and intuitive behavior.

Interpersonal information exchange through the medium of social networking provides one of the fastest growth areas on the Internet. Shared media content and original media including audio, video and graphic information are included in this traffic. Various platforms have been developed to support this exchange in a broad category of human interest and social networking subjects. Such platforms may include by way of example:

browsers

search engines

online gaming

interactive learning

interpersonal relations

multi-user multimedia

remote training

Internet broadcasting

Access to media content information and other data on the Internet is primarily enabled by dedicated server architecture. This type of server centric distribution manages data, tasks and functions through software programs and fixed hardware environments. The extensibility of server centric models is limited by exponential hardware increases and concomitant processing requirements. Alternative forms of architecture have been explored in a limited way through the introduction of shared peer-to-peer programs and applications for specialized platforms.

Data representation is a necessary tool in many scientific fields and is of particular importance in the development of computer languages. Global communications and networking have expanded the global information database by many orders of magnitude in the last decade. Additional data is being created at exponential rates and infrastructure is in constant development to support increased distribution. The majority of data currently distributed by computers or computing devices is in the form of data expressed as text and/or data expressed as binary code. Alphanumeric languages or schemes permeate the entire Internet database.

Early stage development of the Internet and many large databases featured primarily alphanumeric data and programs. Subsequent development of applications and software tools introduced more content in visual, graphic and audio formats. These formats required very large data files for storage, access and distribution. Various Internet standards bodies and working committees have combined together to provide or propose protocols that utilize object-oriented features and advanced compression algorithms for managing, storing, identifying and distributing content. There is a large scale, ongoing global effort dedicated to the need for improved data representation schemes and methodologies. Data has become the subject of many different identification requirements, which include locators, tags, descriptors, labels or similar devices. When related to particular kinds or categories of data, these identifying means are often referred to as metadata and permit descriptions with a high level of detail and feature content to be attached or implemented in connection with audio, video and graphic files.

The availability of information plays a critical role in every significant aspect of human affairs and society. This includes: government, security, education, health, commerce, world affairs, communications, research, music, arts, entertainment, literature, science, broadcasting, journalism, transportation, shipping, railways, air traffic, law enforcement, traffic control, medicine, politics, technology, banking, etc. All of the data that represents this information is contained in various digital formats. The invention described here in would provide improved data compression with benefits in all of the significant fields that concern data, e.g. security, encryption, storage, transmission, retrieval, distribution and management.

Exploration of mathematical theories to express the behavior of complex interactions between time and space led to the development of equations and algorithms that describe the process. The dynamics of kinetic systems can be represented in a geometric fashion by the use of mathematical algorithms. Many of the most important branches of science and physics are concerned with the activity of linear and nonlinear physical systems. Efficient algorithms provide the key to computing complex spatial and temporal relationships. These types of algorithm are frequently referred to as transforms and have been used among other things to plot the motion and momenta of particles in space or simulations of particles in space for computational, analytical or other purposes.

In the current Information Society data frequently consists of an object or symbol repeated as a string of objects or symbols or as a plurality of strings of objects or symbols such as in a binary code. Data may also be composed of alphanumeric characters and symbols in the form of text.

### BRIEF SUMMARY OF THE INVENTION

This invention concerns a method or means to provide an architecture for distribution of data and access on or over any one or many forms of communications, telecommunications, information, Internet or Intranet access infrastructure. Said architecture may include a means or method of data compression by the use of software coding for objectification, visualization or integration of data. The method of use of the invention described herein may include a search engine or browser platform. This invention further concerns a method and means to use mathematical algorithms or transforms to plot the motion and momenta of real or simulated particles in space. Said method may include a means to represent such data as bounded spatial coordinates in a many body system and to express such data as a bounded figure which may include a curve or any other form. The method of such representation may include a means for the purpose of one or any of data reduction, encryption, security, duplication, compression, storage, transmission, distribution, management or any other purpose. In a further aspect of this invention data may be represented as a two-dimensional planar curve corresponding to the positions and momenta of the parametric transform particles.

In an exemplary embodiment of the invention described herein algorithmic formulae generally understood by reference to the descriptions listed herein to use some of the following features or methods may be employed to address coding issues. Such formula may include by way of example some or all of the following or any other related or similar algorithmic formula:

Nearest Neighbor

Parent and child

Mother and daughter

Aggregation

Congruity

Agglomeration

Affinity

Consanguinity

Digital signal processing

Nonlinear signal processing

Nonlinear math

Positional data representation

Spatial relationships

Quadratic harmonics

Exponential dynamics

Positional exponents

Supra-positional exponents

Chaotic attractors

Wavelet transforms

In an exemplary embodiment the invention described herein may include a search engine, browser or peer-to-peer platform with some or all of the following features. Said platform may include a combination of any or all of the features in singular or plural mode.

Distributed shared functionality

Specialized media access

Wavelet transforms

Data objectification code

Multi-media metadata integration

Semantic overlays

Descriptors

Automated data objectification

Data mining

Feature extraction

Database indexing

Consumer profiling

Data profiling

Automated data visualization

Automated clusters and affinities

Internet access management

In a further embodiment of the invention described herein distributed shared functionality may provide an extensible architecture by enabling tasks and functions currently expressed in dedicated hardware and software to be distributed, shared and executed on peer-to-peer nodes throughout the entire network. This may be accomplished by programming software functions to distribute and share server traffic and management tasks in a virtual network environment. Distributed shared functionality may include extensibility, automation, adaptation and intuition. Software functions may replace all or part of the dedicated hardware infrastructure in a more flexible model.

In an exemplary embodiment of this invention a search engine or browser platform may include or be interoperable with a variety of Internet protocols. In order to interface with multiple open source software, proprietary software and/or shared software programs and applications a search engine or browser platform should contain features that allow universal interface capabilities. The following list is not intended to limit or exclude in any way Internet protocols that are not described herein. It is the intention of this example and embodiment merely to identify certain specific protocols that may be used or included as follows:

IPMP

XML

XMLA

XMLS

XPFE

API

RDF

This invention concerns a method and means to represent data as bounded spatial coordinates in a many body system expressed as a curve. The benefits of such representation would include a more efficient means for data reduction, compression, storage, distribution, management and any other purpose. In an exemplary embodiment of this invention data may be represented as a two-dimensional planar curve corresponding to the positions and momenta of the parametric transform particles. Elements of any data can be assigned an arbitrary value as distributed particles and mirror images of those distributed particles. Coordinates can be arbitrarily determined for the position and momenta of those particles. Data can be mapped to the system using those particles and coordinates.

### BRIEF DESCRIPTION OF THE DRAWINGS

Not Applicable.

### DETAILED DESCRIPTION OF THE INVENTION

This invention concerns a method to create a form of data distribution architecture. The method of such invention may use a plurality of means including software coding and features. Said features may include objectification, visualization or integration of data with automated functions. This invention concerns a method or means to provide an architecture for distribution of data and access on or over any one or many forms of communications, telecommunications, information, Internet or Intranet access infrastructure. Said architecture may include a means or method of data compression by the use of software coding for objectification, visualization or integration of data. The method of use of the invention described herein may include one or a plurality of search engines or browser platforms.

This invention further concerns a method and means to use mathematical algorithms or transforms to plot the motion and momenta of real or simulated particles in space. Said method may include a means to represent such data as bounded spatial coordinates in a many body system and to express such data as a bounded figure which may include a curve or any other form. The method of such representation may include a means for the purpose of one or any of data reduction, encryption, security, duplication, compression, storage, transmission, distribution, management or any other purpose. In a further aspect of this invention data may be represented as a two-dimensional planar curve corresponding to the positions and momenta of the parametric transform particles.

In an exemplary embodiment the invention described herein may include a search engine, browser or peer-to-peer platform with some or all of the following features. Said platform may include a combination of any or all of the features in singular or plural mode.

Distributed shared functionality

Specialized media access

Wavelet transforms

Data objectification code

Multi-media metadata integration

Semantic overlays

Descriptors

Automated data objectification

Data mining

Feature extraction

Database indexing

Consumer profiling

Data profiling

Automated data visualization

Automated clusters and affinities

Internet access management

In an exemplary embodiment the method of enabling the various functions, tasks or features of the invention described herein may include performing the operation of some or all of the following steps. This description of the operation and steps performed is not intended to be exhaustive or complete or to exclude the performance or operation of any additional steps or the performance or operation of any such steps or the following steps in any different sequence or order.

Develop or acquire the required source code and software

Design or acquire a search engine

Design or acquire a browser

Design or acquire a platform for specialized media access

Integrate source code and software

Integrate distributed shared functionality

Integrate data mining features

Integrate data profiling features

Integrate data indexing features

Integrate feature extraction functions

Combine all of the design elements

Combine all of the features and functions

Enable application program interface

Interface with required applications or programs

Partner with subject program applications

Assimilate subject programs

Activate search engine

Activate browser

Activate platform

Launch search engine

Launch browser

Launch platform

Launch combined search engine, browser or platform

Test search engine

Test browser

Test platform

Test combined search engine, browser or platform

In an exemplary embodiment the invention described herein may include a search engine, browser or peer-to-peer platform embodying some or all of the following features. Said platform may include a combination of any or all of the features in singular or plural mode.

Distributed shared functionality

Specialized media access

Wavelet transforms

Data objectification code

Multi-media metadata integration

Semantic overlays

Descriptors

Automated data objectification

Data mining

Feature extraction

Database indexing

Consumer profiling

Data profiling

Automated data visualization

Automated clusters and affinities

Internet access management

Exploration of mathematical theories to express the behavior of complex interactions between time and space led to the development of equations and algorithms that describe the process. The dynamics of kinetic systems can be represented in a geometric fashion by the use of mathematical algorithms. Many of the most important branches of science and physics are concerned with the activity of linear and nonlinear physical systems. Efficient algorithms provide the key to computing complex spatial and temporal relationships. These types of algorithm are frequently referred to as transforms and have been used to plot the motion and momenta of particles in space or simulations of particles in space for computational, analytical or other purposes. In the current Information Society data frequently consists of an object or symbol repeated as a string of objects or symbols or as a plurality of strings of objects or symbols such as in a binary code. Data may also be composed of alphanumeric characters and symbols in the form of text.

In an exemplary embodiment the method of enabling the various functions, tasks or features of the invention described herein may include performing the operation of some or all of the following steps. This description of the operation and steps performed is not intended to be exhaustive or complete or to exclude the performance or operation of any additional steps or the performance or operation of any such steps or the following steps in any different sequence or order.

Assign an arbitrary value to data

Assign particle functions

Determine coordinates

Choose a means to plot the curve

Choose a method for distribution of particles

Define the parameters

Input value N

Input value 0

Construct a matrix

Input subject data

Activate recursive loop function

Calculate data

Calculate position

Calculate value

Display sum

Input sum

Choose curve display parameter

Plot unit circle

Plot particles

Plot unit circle

Calculate curve in real space

Plot curve

The foregoing means and method are described as exemplary embodiments of the inventions. These examples are intended to demonstrate that any of the aforementioned steps may be used alone or in conjunction with any other steps in the sequences described and in any other sequences.

It will be apparent to any of those persons who are knowledgeable and skilled in the art that the aforementioned descriptions are merely examples of possible methods of enabling the inventions described. These descriptions are not intended in any way to limit or exclude alternative embodiments or uses of the inventions. All and any forms or embodiments or uses of the inventions are considered to be addressed and taught by the methods and descriptions illustrated and contained herein.

It is understood that the terms and descriptions used in connection with the devices, examples or implementations described herein are for illustrative purposes only and any variation, modifications or changes therein are intended to be included within the spirit and purview of this application and scope of the appended claims and combinations thereof.

It is also understood that the examples and implementations described herein are for illustrative purposes only and that various modifications or changes in light thereof will be suggested to persons skilled in the art and are to be included within the spirit and purview of this application and scope of the appended claims and combinations thereof.

What is claimed is:

1. A method to provide at least an architecture for at least distribution of at least data and at least access on or over any one or many forms of at least communications, at least telecommunications, at least information, at least Internet or at least Intranet access infrastructure.

2. The method of claim 1, to create at least a form of at least data distribution architecture which includes at least a means of at least software coding and at least software features so as to include some or all of the following steps:
where at least data is at least compressed by the use of at least functions which may be at least automated,
where at least data is at least objectified by the use of at least functions which may be at least automated,
where at least data is at least visualized by the use of at least functions which may be at least automated,
where at least data is at least integrated by the use of at least functions which may be at least automated,
where at least mathematical or at least algorithmic formulae may at least be used to at least address at least software coding,
where at least mathematical or at least algorithmic formulae may at least be used to at least address at least software features,
where at least such formulae may include at least some or all of the following or any other related or similar algorithmic formula, e.g. nearest neighbor, parent and child, mother and daughter, aggregation, congruity, agglomeration, affinity or consanguinity,
where at least such methods may include at least such mathematical or algorithmic formulae as may be used to address at least coding and at least software design, e.g. digital signal processing, nonlinear signal processing, nonlinear math, positional data representation, spatial relationships, quadratic harmonics,
where at least such methods may include at least such mathematical or algorithmic formulae as may be used to address at least coding and at least software design, e.g. exponential dynamics, positional exponents, supra-positional exponents, chaotic attractors or wavelet transforms.

3. The method of claim 1, to provide at least a search engine, which includes at least a browser or at least a platform which can at least address at least bandwidth and at least data compression by means of some or all of the following:
where at least a browser or at least a platform includes at least distributed shared functionality,
where at least a browser or at least a platform includes at least a peer-to-peer architecture,
where at least a browser or at least a platform includes at least specialized media access,
where at least a browser or at least a platform includes at least wavelet transforms,
where at least a browser or at least a platform includes at least data objectification code,
where at least a browser or at least a platform includes at least multi-media metadata integration,
where at least a browser or at least a platform includes at least semantic overlays,
where at least a browser or at least a platform includes at least descriptors,
where at least a browser or at least a platform includes at least automated data objectification,
where at least a browser or at least a platform includes at least data mining,
where at least a browser or at least a platform includes at least feature extraction,
where at least a browser or at least a platform includes at least database indexing,
where at least a browser or at least a platform includes at least consumer profiling,
where at least a browser or at least a platform includes at least demographic profiling,
where at least a browser or at least a platform includes at least data profiling,
where at least a browser or at least a platform includes at least automated data visualization,
where at least a browser or at least a platform includes at least automated clusters and affinities,
where at least a browser or at least a platform includes at least Internet access management,
where at least a browser or at least a platform includes at least a source code and at least software using at least non-linear waveforms,
where at least a browser or at least a platform includes at least a source code and at least software using at least wavelet math transforms.

4. The method of claim 1, to at least develop at least a search engine, at least a browser or at least a platform which may include some or all of the following features and require some or all of the following steps:
where at least the required source code and at least the required software is at least developed or at least acquired,
where at least a search engine is at least designed or at least acquired,
where at least a browser is at least designed or at least acquired,
where at least a platform for specialized media access is at least designed or at least acquired,
where at least a peer-to-peer architecture is at least designed or at least acquired,
where at least the required source code and at least the required software are at least integrated,
where at least distributed shared functionality is at least integrated,
where at least a peer-to-peer architecture is at least integrated,
where at least data mining features are at least integrated,
where at least data profiling features are at least integrated,
where at least data indexing features are at least integrated,
where at least feature extraction functions are at least integrated,
where at least the design elements are at least combined,
where at least the features and functions are at least combined,
where at least an application program interface is at least enabled,
where at least a required application or program is at least interfaced,
where at least a subject program application is at least partnered,
where at least subject programs are at least assimilated,
where at least a search engine is at least activated,
where at least a browser is at least activated,
where at least a platform is at least activated,
where at least a search engine is at least launched,
where at least a browser is at least launched,
where at least a platform is at least launched,
where at least a combination of at least a search engine, at least a browser or at least a platform is at least launched,
where at least a search engine is at least tested,
where at least a browser is at least tested,
where at least a platform is at least tested,
where at least a combination of at least a search engine, at least a browser or at least a platform is at least tested.

5. The method of claim 1, whereby at least a search engine, at least a browser or at least a platform may at least include or at least be interoperable with at least Internet protocols that at least permit at least universal interface capabilities where said operation requires at least some or all of the following:
whereby, at least a search engine, at least a browser or at least a platform may at least interface with at least such protocols, e.g. IPMP, XML, XMLA, XMLS, XPFE, API or RDF,
whereby, at least a search engine, at least a browser or at least a platform may at least interface with at least multiple open source software, at least proprietary software, at least shared software programs and at least shared software applications.

6. A method to use at least mathematical algorithms or at least mathematical transforms to at least plot at least the motion and at least the momenta of at least real or at least simulated particles in space; said method may include a means to represent such data as bounded spatial coordinates in a many body system and to express such data as a bounded figure which may include a curve or any other form, which may be used for any or all of the following purposes or any other purpose:
whereby, at least the method of at least such representation may include at least data reduction,
whereby, at least the method of at least such representation may include at least data encryption,
whereby, at least the method of at least such representation may include at least data compression,
whereby, at least the method of at least such representation may include at least data duplication,
whereby, at least the method of at least such representation may include at least data protection,
whereby, at least the method of at least such representation may include at least data storage,
whereby, at least the method of at least such representation may include at least data transmission,
whereby, at least the method of at least such representation may include at least data retrieval,
whereby, at least the method of at least such representation may include at least data distribution,
whereby, at least the method of at least such representation may include at least data management.

7. The method of claim 6, whereby at least data may be at least represented as at least a two-dimensional planar curve at least corresponding to at least the positions and at least the momenta of at least the real or at least the simulated parametric transform particles.

8. The method of claim 6, whereby at least elements of at least data may be assigned at least an arbitrary value as at least distributed particles and at least mirror images of at least those distributed particles; whereby at least coordinates can be at least arbitrarily determined for at least the position and at least the momenta of at least those particles; whereby at least data can at least be mapped to at least the system using at least those particles and at least those coordinates.

9. The method of claim 6, whereby at least enabling at least the functions, at least the tasks or at least the features of the invention described herein may at least include at least performing the operation of at least some or all of the following steps:
whereby, at least an arbitrary value is at least assigned to at least data.
whereby at least functions are at least assigned to at least particles,
whereby at least coordinates are at least determined,
whereby at least a means to at least plot at least the curve is at least determined,
whereby at least a method for at least distribution of at least particles is at least determined,
whereby at least the parameters are at least defined,
whereby at least a value N is at least input,
whereby at least a value 0 is at least input,
whereby at least a matrix is at least constructed,
whereby at least subject data is at least input,
whereby at least a recursive loop function is at least activated,
whereby at least data is at least calculated,
whereby at least a position is at least calculated,
whereby at least a value is at least calculated,
whereby at least a sum is at least displayed,
whereby at least a sum is at least input,
whereby at least a curve display parameter is at least determined,
whereby at least a unit circle is at least plotted,
whereby at least a particle is at least plotted,
whereby at least the function of at least plotting at least a unit circle is at least repeated,
whereby at least one or more particles are at least plotted,
whereby at least a curve in real space is at least calculated,
whereby at least a curve is at least plotted.
